(19) United States
(12) Patent Application Publication
(10) Pub. No.: US 2024/0301280 A1
(43) Pub. Date: Sep. 12, 2024

(54) QUANTUM DOT PRODUCTION METHOD AND QUANTUM DOTS

(71) Applicant: SHARP KABUSHIKI KAISHA, Sakai city, Osaka (JP)

(72) Inventor: Masumi KUBO, Sakai City, Osaka (JP)

(21) Appl. No.: 18/034,339

(22) PCT Filed: Nov. 20, 2020
(86) PCT No.: PCT/JP2020/043299

§ 371 Date: Apr. 27, 2023

(51) Int. Cl. C09K 11/06

(52) U.S. Cl. CPC C09K 11/06; C09K 2211/18

(57) ABSTRACT

A quantum dot production method for producing quantum dots made of core particles and shells formed on outer surfaces of the core particles, the quantum dot production method includes: a preparing step of mixing a solution and a shell precursor together, in order to prepare a reaction solution, the solution containing a solvent and the core particles: a heating step of irradiating the core particles with light either in the solution or the reaction solution and generating heat, in order to heat surroundings of the core particles; and a shell forming step of causing reaction of the shell precursor on the outer surfaces of the core particles in the reaction solution, in order to form the shells on the outer surfaces of the core particles.

### TECHNICAL FIELD

The present disclosure relates to a quantum dot production method and quantum dots.

### BACKGROUND ART

Patent Document 1 discloses, for example, core-shell semiconductor nanoparticles (quantum dots), and a ligand bound to the semiconductor nanoparticles.

### CITATION LIST

### Patent Document

[Patent Document 1] Japanese Unexamined Patent Application Publication No. 2017-025220

### SUMMARY

### Technical Problem

However, it is difficult to form a shell uniformly on the outer surface of a core particle, and what is desired is a quantum dot production method capable of forming shells more uniformly.

A main object of the present disclosure is to provide a quantum dot producing method for producing quantum dots made of core particles and shells on the outer surfaces of the core particles. The method can form the shells more uniformly.

### Solution to Problem

A quantum dot production method according to an aspect of the present disclosure is directed to a method for producing quantum dots made of core particles and shells formed on outer surfaces of the core particles The quantum dot production method includes: a preparing step of mixing a solution and a shell precursor together, in order to prepare a reaction solution, the solution containing a solvent and the core particles; a heating step of irradiating the core particles with light either in the solution or the reaction solution and generating heat, in order to heat surroundings of the core particles; and a shell forming step of causing reaction of the shell precursor on the outer surfaces of the core particles in the reaction solution, in order to form the shells on the outer surfaces of the core particles.

### BRIEF DESCRIPTION OF DRAWINGS

FIG. 1 is a flowchart showing an example of a quantum dot production method according to a first embodiment.

FIG. 2 is a graph illustrating a relationship between time and temperature as to the quantum dot production method according to the first embodiment.

FIG. 3 is a flowchart showing an example of a quantum dot production method according to a second embodiment.

FIG. 4 is a graph illustrating a relationship between time and temperature as to the quantum dot production method according to the second embodiment.

### DESCRIPTION OF EMBODIMENTS

Embodiments described below are mere examples of the present disclosure. The present disclosure shall not be limited to the embodiments below.

### First Embodiment

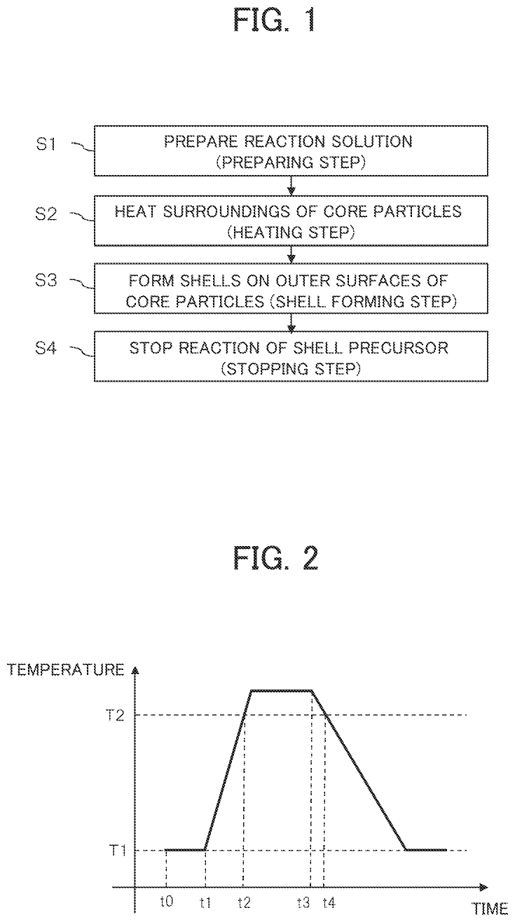

FIG. 1 is a flowchart showing an example of a quantum dot production method according to this embodiment. FIG. 2 is a graph illustrating a relationship between time and temperature as to the quantum dot production method according to this embodiment. Quantum dots produced in the present embodiment are core-shell quantum dots.

The quantum dot production method of this embodiment includes, as seen in FIG. 1, for example, a preparing step (S1), a heating step (S2), a shell forming step (S3), and a stopping step (S4). Note that the steps may overlap in timing with each other.

At the preparing step (S1), for example, a reaction solution is prepared. More specifically, the preparing step involves mixing a first solution and a shell precursor together, in order to prepare the reaction solution. The first solution contains a first solvent and core particles.

The first solvent may allow the shell precursor to dissolve or disperse therein, and the core particles to disperse therein. Examples of the first solvent include high-boiling solvents such as trioctylphosphine oxide and hexadecylamine. A boiling point of the first solvent is preferably above a lowest shell growth temperature T2 to be described later.

The core particles are quantum dots each substantially made only of, for example, a core. Examples of the core particles include a group II-VI semiconductor such as CdSe, CdTe, ZnTe, or CdS, and a group III-V semiconductor such as InP or InGaP. The core particles generate heat when irradiated with, for example, light having a predetermined wavelength.

The shell precursor contains, for example, one or more compounds to form a shell by reaction on an outer surface of each core particle. The shell precursor is resolved at the lowest shell growth temperature T2. Then, the resolvent of the shell precursor epitaxially grows to form the shells on the outer surfaces of the core particles at the lowest shell growth temperature T2 or above. The lowest shell growth temperature T2 is, in other words, a temperature at which the shell precursor resolves and the resolvent of the shell precursor epitaxially grows on the outer surfaces of the core particles.

The shell precursor contains a shell-forming element such as, for example, Cd, Se, or Te. An example of the compound for forming the shells on the outer surfaces of the core particles includes an organic metal. Moreover, the shell precursor may be, for example, dissolved into the first solvent and used in the form of a solution.

The heating step (S2) involves heating surroundings of the core particles. More specifically, the heating step involves irradiating the core particles with light either in the first solution or the reaction solution and generating heat, in order to heat the surroundings of the core particles. In other words, the core particles are irradiated with light to generate heat, thereby heating the first solvent or the first solution surrounding the core particles. The light with which the core particles are irradiated is, for example, an ultraviolet ray. At the heating step, the core particles generate and apply the heat. Hence, the temperature is less likely to rise at a location away from the core particles. At the heating step, for example, the surroundings of the core particles are heated to the lowest shell growth temperature T2 or above. Moreover, at the heating step, the heat is generated by the core particles with light. In addition, the heat may be applied with, for example, a heater. However, the heat is applied preferably only by irradiation with light. Such a feature makes it possible to form the shells while a large temperature difference is maintained between the surroundings of the core particles and a location away from the core particles, thereby successfully producing the quantum dots more uniformly.

The heating step starts at a time point t1 (see FIG. 2). That is, for example, at the time point t1, the core particles start to be irradiated with light. The light with which the core particles are irradiated may include a predetermined wavelength at which the core particles generate heat. Note that the core particles generate heat at various wavelengths, depending on a material and a particle size of the core particles.

The shell forming step (S3) involves, for example, forming the shells on the outer surfaces of the core particles. More specifically, the shell forming step involves causing reaction of the shell precursor on the core particles in the reaction solution in which the surroundings of the core particles are heated at the heating step, in order to form the shells on the outer surfaces of the core particles. Because, at the heating step, the surroundings of the core particles are heated to the lowest shell growth temperature T2 or above, the shell precursor resolves in the surroundings of the core particles, and the resolvent of the shell precursor epitaxially grows as the shells on the outer surfaces of the core particles Moreover, at the shell forming step, the temperature is maintained at the lowest shell growth temperature T2 or above. The temperature in the surroundings of the core particles can be adjusted by, for example, controlling intensity of the light with which the core particles are irradiated.

The shell forming step starts at various time points, depending on a time point at which the shell precursor is charged. For example, if the reaction solution is prepared before reaching the lowest shell growth temperature T2, the shell forming step starts at a time point at which the reaction solution reaches the lowest shell growth temperature T2; that is, at a time point t2. Moreover, for example, if the reaction solution is prepared after reaching the lowest shell growth temperature T2, the shell forming step starts at a time point at which the shell precursor is charged into the first solution after the time point t2. At the shell forming step, it is particularly preferable to quickly charge the shell precursor into the first solution while the first solution is heated. Such a feature makes it possible to keep the shell precursor from forming second core particles different from the above core particles.

Furthermore, at the shell forming step, a thickness of the shells and a particle size of the quantum dots can be adjusted by controlling, for example, a time period for forming the shells; that is, a time period from when the shell forming step starts until when the shells stop forming (e.g., t4). In addition, at the shell forming step, the thickness of the shells and the particle size of the quantum dots can be adjusted by, for example, controlling intensity of the light irradiation to adjust the temperature in the surroundings of the core particles.

Note that, at the shell forming step, the surroundings of the core particles are heated by the light irradiation. The shells are formed preferably within a time period in which a difference is observed between the temperature in the surroundings of the core particles and the temperature in a location away from the core particles. Moreover, the shells are formed preferably by the time at which the temperature of the location away from the core particles in the reaction solution reaches the lowest shell growth temperature T2. Such a feature makes it possible to keep the shell precursor from forming the second core particles.

The stopping step (S4) involves, for example, stopping the reaction of the shell precursor. That is, the temperature, in the surroundings of the core particles on which the shells are formed, is decreased below the lowest shell growth temperature T2, and the resolution of the shell precursor is stopped. Thus, the epitaxial growth of the shells is stopped. In order to decrease the temperature in the surroundings of the core particles on which the shells are formed, the light irradiation is stopped. Moreover, if the reaction solution is heated with, for example, a heater, the heater is stopped. The light irradiation is stopped, and/or the heater is stopped, at a time point t3, and the temperature of the reaction solution starts to be decreased. At a time point t4, the temperature, in the surroundings of the core particles on which the shells are formed, is decreased to the lowest shell growth temperature T2. After that, the temperature of the reaction solution is decreased to an ambient temperature T1. Note that, for example, at the stopping step, the reaction solution may be forcibly cooled and the temperature of the reaction solution may be quickly decreased. Such a feature makes it possible to reduce the risk that the shells epitaxially grow beyond a desired thickness, and to produce the quantum dots more uniformly.

Moreover, each of the steps is preferably carried out in an atmosphere of such an inert gas as a nitrogen gas.

Through the above steps, the core-shell quantum dots are successfully produced. The above method can also be referred to as a method for producing a solution containing the core-shell quantum dots.

To the reaction solution, a first ligand may be added. In the reaction solution, the first ligand can keep the formed core-shell quantum dots from aggregating together. Moreover, the first ligand allows the core particles to disperse uniformly in the reaction solution, and the shells can be uniformly formed among the core particles. Such a feature makes it possible to obtain a solution in which the core-shell quantum dots are dispersed more uniformly.

Examples of the first ligand include alkylphosphines such as trioctylphosphine (melting point: 30° C.), alkylphosphine oxides such as trioctylphosphine oxide (melting point: 50 to 54° C.), long-chain carboxylic acids such as oleic acid (melting point: 13 to 14° C.), and long-chain amines such as oleic amine (melting point: 18 to 26° C.).

Note that the first ligand is added to the first solution preferably between a time point t0 to the time point t2. Moreover, the first ligand has a melting point preferably below the lowest shell growth temperature T2, and, more preferably, below the ambient temperature T1. Furthermore, the first ligand dissolves preferably in the first solvent.

When the first solution is prepared, preferably, a mixture of the first solvent and the first ligand is prepared and the shell precursor is added to this mixture. Moreover, if the melting point of the first ligand is between the ambient temperature T1 and the lowest shell growth temperature T2, preferably, the mixture of the first solvent and the first ligand is heated to the melting point of the first ligand or above, and subsequently, the shell precursor is added to the heated mixture. Such a feature makes it possible to uniformly disperse the shell precursor in the reaction solution, and the shell can be formed more uniformly on the outer surfaces of the core particles.

Note that, using InP core particles having a particle size of 2 nm and a Zn (O₂C₂H₃)₂ shell precursor, core (InP)-shell (ZnS) quantum dots are produced by the above method. When the obtained reaction solution is irradiated with light, a spectrum of the light emitted from the quantum dots exhibits a single wavelength peak. Whereas, in the above method, the reaction solution is not irradiated with light but heated when the core (InP)-shell (ZnS) quantum dots are produced, using the InP core particles having a particle size of 2 nm and the Zn (O₂C₂H₃)₂ shell precursor. When the obtained reaction solution is irradiated with light, a spectrum of the light emitted from the quantum dots is clearly separated into a plurality of wavelength peaks. In other words, as seen in the above method, when the surroundings of the core particles are irradiated with light and heated, the shells are found to be formed uniformly on the core particles.

According to the quantum dot production method of this embodiment, only the surroundings of the core particle are irradiated with light and heated so that the shells are formed on the outer surfaces of the core particles. Thanks to such a feature, the temperature of a location away from the core particles does not rise to a lowest shell forming temperature at which the shell precursor reacts, thereby successfully reducing possibility of forming the second core particles from the shell precursor. Moreover, because only the surroundings of the core particles reach the lowest shell formation temperature, the epitaxial growth on the outer surfaces of the core particles becomes predominant. Such a feature makes it possible to reduce formation of the second core particles from the shell precursor. Hence, the feature makes it possible to form the shells well on the outer surfaces of the core particles, and to reduce the second core particles; namely, impurities.

Furthermore, it is generally difficult to separate the second core particles from the quantum dots made of the core particles and the shells formed on the outer surfaces of the core particles. However, the quantum dot production method of this embodiment eliminates the need of such a separating step.

### Second Embodiment

This embodiment corresponds to the step of preparing the first solution according to the first embodiment. In other words, this embodiment is directed to a core particle production method.

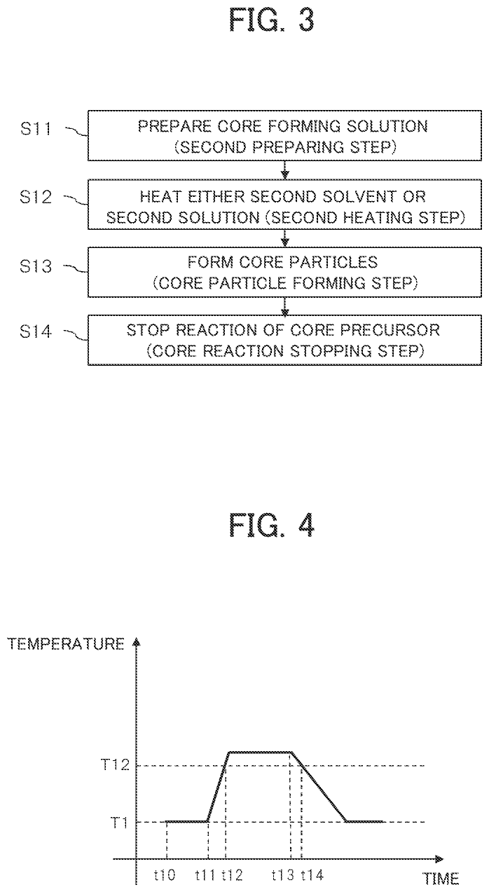

FIG. 3 is a flowchart showing the core particle production method according to this embodiment. FIG. 4 is a graph illustrating a relationship between time and temperature as to the core particle production method according to this embodiment.

The core particle production method of this embodiment includes, as seen in FIG. 3, for example, a second preparing step (S11), a second heating step (S12), a core particle forming step (S13), and a core reaction stopping step (S14). Note that the steps may overlap in timing with each other.

The second preparing step (S11) involves, for example, mixing a second solvent and a core precursor together, in order to prepare a second solution (a core forming solution).

The second solvent may allow the core precursor to dissolve or disperse therein, and the generated core particles to disperse therein. Examples of the second solvent include high-boiling solvents such as trioctylphosphine oxide and hexadecylamine. A boiling point of the second solvent is preferably above a lowest core growth temperature T12.

The core precursor contains, for example, one or more compounds to form cores by reaction. For example, the core precursor contains a core particle forming element. For example, the core precursor resolves at the lowest core growth temperature T12. Then, for example, the core particles are formed of the resolvent of the core precursor to epitaxially grow. An example of a compound for forming the core particles includes an organic metal containing a core particle forming element. Moreover, the core precursor may be, for example, dissolved into the second solvent and used in the form of a solution.

The second heating step (S12) involves, for example, heating either the second solvent or the second solution (the core forming solution).

In order to prepare the second solution, the core precursor is charged into the second solvent preferably when, for example, a temperature of the second solvent is higher than, or equal to, the lowest core growth temperature T12 at which the core precursor reacts to form the core particles.

The core particle forming step (S13) involves, for example, forming the core particles in the second solution. More specifically, the core particle forming step involves causing reaction of the core precursor in the heated second solution in order to form the core particles. At the second heating step, the second solution is heated to the lowest core growth temperature T12 or above. Hence, the core precursor resolves and the resolvent of the core precursor epitaxially grows. Moreover, at this core forming step, the second solution is maintained at the lowest core growth temperature T12 or above. In adjusting the temperature of the second solution, for example, a heater is used. The heater may be controlled to adjust the temperature of the second solution.

The core forming step starts at various time points, depending on a time point at which the core precursor is charged. For example, if the second solution is prepared before reaching the lowest core growth temperature T12, the core forming step starts at a time point at which the second solution reaches the lowest core growth temperature T12; that is, at a time point t12. Moreover, for example, if the second solution is prepared after reaching the lowest core growth temperature T12, the core forming step starts at a time point at which the core precursor is charged into the second solvent after the time point t12. At the second preparing step, it is particularly preferable to quickly charge the core precursor into the second solvent while the second solvent is heated. Such a feature makes it possible to form the core particles more uniformly from the core precursor.

Furthermore, at the core forming step, a particle size of the core particles can be adjusted by controlling, for example, a time period for forming the core particles; that is, a time period from when the core forming step starts until when the core particles stop forming (e.g., t14). In addition, at the core forming step, the particle size of the core particles can be adjusted by, for example, adjusting the temperature of the second solution.

The core reaction stopping step (S14) involves, for example, stopping the reaction of the core precursor. More specifically, the core reaction stopping step involves decreasing the temperature of the second solution below the lowest core growth temperature T12, in order to stop the resolution of the core precursor and to stop the epitaxial growth of the core particles. For example, the heater is stopped so that the temperature of the second solution decreases below the lowest core growth temperature T12. The heater is stopped at a time point t13, and the temperature of the second solution starts to be decreased. At a time point t14, the temperature in the surroundings of the core particles is decreased to the lowest core growth temperature T12. After that, the temperature of the second solution is decreased to an ambient temperature T11. Note that, for example, at the core reaction stopping step, the second solution may be forcibly cooled and the temperature of the second solution may be forcibly decreased.

Moreover, each of the steps is preferably carried out in an atmosphere of such an inert gas as a nitrogen gas.

Through the above steps, the core particles are successfully produced. In other words, a solution containing the core particles; that is, the first solution, is successfully produced.

Note that, to the second solution, for example, a second ligand may be added. The added second ligand can keep the core particles, formed in the second solution, from aggregating together. Such a feature makes it possible to obtain a solution in which the core particles are dispersed more uniformly.

The second ligand is, for example, similar to the first ligand. A melting point of the second ligand is preferably below the lowest core growth temperature T12. Moreover, the second ligand dissolves preferably in the second solvent. Note that the second ligand is added to the second solvent preferably between a time point t10 to the time point t12. Furthermore, at the second preparing step, a mixture of the second solvent and the second ligand may be prepared, and the core precursor may be charged into this mixture.

Moreover, if the melting point of the second ligand is between the ambient temperature T1 and the lowest core growth temperature T12, preferably, the mixture of the second solvent and the second ligand is heated to the melting point of the second ligand or above, and subsequently, the core precursor is charged into the heated mixture. Such a feature makes it possible to produce the core particles in the second solution more uniformly.

Furthermore, the second solution containing the obtained core particles may be refined so that the impurities (e.g., the core precursor and the second ligand) may be partially or entirely removed. Hence, when the shells are formed later on the outer surfaces of the core particles, the shells can be formed more precisely. The refining may involve, for example, adding such a substance as methanol to the second solution containing the obtained core particles, and centrifugally separating the core precursor and the second ligand. Moreover, the refined core particles may be taken out and dispersed in another solvent different from the second solvent.

Note that, as the second solvent of this embodiment, the first solvent of the first embodiment is preferably used. Thanks to such a feature, for example, the second solution containing the core particles can be used as the first solution, and the core particles and the shells on the outer surfaces of the core particles can be formed without changing solvents. Hence, compared with a case where the first solvent and the second solvent are different solvents, the number of the steps can be reduced in producing core-shell quantum dots.

Moreover, as the second ligand, the first ligand of the first embodiment is preferably used. Hence, compared with a case where different ligands are used, the number of the steps, such as, for example, a step of adding the second ligand, can be reduced in producing core-shell quantum dots.

The present disclosure shall not be limited to the above embodiments, and may be replaced with configurations that are substantially the same as, that have the same advantageous effects as those of, and that achieve the same object as that of, the configurations described in the above embodiments.

1. A quantum dot production method for producing quantum dots made of core particles and shells formed on outer surfaces of the core particles, the quantum dot production method comprising:
a preparing step of mixing a solution and a shell precursor together, in order to prepare a reaction solution, the solution containing a solvent and the core particles;
a heating step of irradiating the core particles with light either in the solution or the reaction solution and generating heat, in order to heat surroundings of the core particles; and
a shell forming step of causing reaction of the shell precursor on the outer surfaces of the core particles in the reaction solution, in order to form the shells on the outer surfaces of the core particles,
wherein the surroundings of the core particles are heated so that a temperature in the surroundings rises to a lowest shell growth temperature or above, and, subsequently, the shell precursor is mixed with the solution, the lowest shell growth temperature being a temperature at which the shell precursor reacts on the outer surfaces of the core particles to form the shells.

2. (canceled)

3. The quantum dot production method according to claim 1,
wherein a temperature in the surroundings of the core particles is decreased below a lowest shell growth temperature, and the reaction of the shell precursor is stopped, the lowest shell growth temperature being a temperature at which the shell precursor reacts on the outer surfaces of the core particles to form the shells.

4. The quantum dot production method according to claim 1,
wherein the solution further contains a ligand.

5. The quantum dot production method according to claim 4,
wherein a mixture of the solvent and the ligand is heated to a melting point of the ligand or above, and, subsequently, the core particles are mixed with the mixture so that the solution is prepared.

6. A quantum dot production method for producing quantum dots made of core particles and shells formed on outer surfaces of the core particles, the quantum dot production method comprising:
a preparing step of mixing a solution and a shell precursor together, in order to prepare a reaction solution, the solution containing a solvent and the core particles;
a heating step of irradiating the core particles with light either in the solution or the reaction solution and generating heat, in order to heat surroundings of the core particles; and
a shell forming step of causing reaction of the shell precursor on the outer surfaces of the core particles in the reaction solution, in order to form the shells on the outer surfaces of the core particles,
wherein the preparing step further includes a core forming step of preparing a core forming solution containing the solvent and a core precursor, and causing reaction of the core precursor in the core forming solution in order to form the core particles, and
as the solution, the core forming solution containing the core particles generated is used.

7. The quantum dot production method according to claim 6,
wherein, at the core forming step, the solvent is heated to a lowest core growth temperature, and, subsequently, the core precursor is mixed with the solvent so that the core forming solution is prepared, the lowest core growth temperature being a temperature at which the core precursor reacts to form the core particles.

8. The quantum dot production method according to claim 6,
wherein the core forming solution is cooled below a lowest core growth temperature, and the reaction of the core precursor is stopped, the lowest core growth temperature being a temperature at which the core precursor reacts to form the core particles.

9. The quantum dot production method according to claim 6,
wherein the core forming solution further contains a ligand.

10. The quantum dot production method according to claim 9,
wherein a mixture of the ligand and the solvent is heated to a melting point of the ligand or above, and, subsequently, the core precursor is mixed with the mixture so that the core forming solution is prepared.

11. Quantum dots produced by the quantum dot production method according to claim 6.

12. Quantum dots produced by the quantum dot production method according to claim 1.

13. A quantum dot production method for producing quantum dots made of core particles and shells formed on outer surfaces of the core particles, the quantum dot production method comprising:
a preparing step of mixing a solution and a shell precursor together, in order to prepare a reaction solution, the solution containing a solvent and the core particles;
a heating step of irradiating the core particles with light either in the solution or the reaction solution and generating heat, in order to heat surroundings of the core particles; and
a shell forming step of causing reaction of the shell precursor on the outer surfaces of the core particles in the reaction solution, in order to form the shells on the outer surfaces of the core particles,
wherein a temperature in the surroundings of the core particles is decreased below a lowest shell growth temperature, and the reaction of the shell precursor is stopped, the lowest shell growth temperature being a temperature at which the shell precursor reacts on the outer surfaces of the core particles to form the shells.

14. The quantum dot production method according to claim 13,
wherein the solution further contains a ligand.

15. The quantum dot production method according to claim 14,
wherein a mixture of the solvent and the ligand is heated to a melting point of the ligand or above, and, subsequently, the core particles are mixed with the mixture so that the solution is prepared.

16. Quantum dots produced by the quantum dot production method according to claim 13.
